(19) United States
(12) Patent Application Publication
(10) Pub. No.: US 2011/0063190 A1
(43) Pub. Date: Mar. 17, 2011

(54) DEVICE AND METHOD FOR CONTROLLING AZIMUTH BEAMWIDTH ACROSS A WIDE FREQUENCY RANGE

(76) Inventors: Jimmy HO, Chatham Kent (GB); Simon Christopher R. Munday, Corby (GB); Charanjit Sailopal, Hitchin (GB); David Harold Boardman, Ipswich (GB); Barry John Talbot, Rugby (GB); Michal Klinkosz, Wellingborough (GB)

(21) Appl. No.: 12/869,429

(22) Filed: Aug. 26, 2010

Related U.S. Application Data
(60) Provisional application No. 61/237,060, filed on Aug. 26, 2009.

(51) Int. Cl. H01Q 15/14; H01P 11/00

(52) U.S. Cl. 343/912; 29/600

(57) ABSTRACT

A system and method for providing a compact azimuth beamwidth in a wide band antenna. The system comprises a first radiating element disposed above a ground plane and one or more parasitic elements disposed proximate to and/or around the first radiating element. Each of the parasitic elements has a slot formed therein that is configured to control beamwidth across a specific frequency range. In one embodiment, the parasitic elements and the slots can be configured to control beamwidth across different frequency ranges. And in another embodiment, another parasitic element is disposed within the slots to control beamwidth across another frequency range.

### CROSS-REFERENCE TO RELATED APPLICATIONS

This application claims the benefit of U.S. Provisional Application Ser. No. 61/237,060, filed Aug. 26, 2010, the entire disclosure of which is hereby incorporated by reference.

### BACKGROUND OF THE INVENTION

1. Field of the Invention

The present invention relates to devices and methods for controlling azimuth beamwidth across a wide frequency range. In particular, the present invention relates to parasitic elements that allow an antenna or an array of antennae to maintain a flat azimuth beamwidth across a broad bandwidth, especially when used in base station applications.

2. Description of the Related Art

Wireless communication networks, such as cellular phone networks, provide broadband, digital voice, messaging, and data services to mobile communication devices, such as cellular phones. Those wireless networks use the Ultra High Frequency (UHF) portion of the radio frequency spectrum to transmit and receive signals. The UHF portion of the radio frequency spectrum designates a range of electromagnetic waves with frequencies between 300 MHz and 3000 MHz. Different wireless communication networks operate within different bands of frequency within that range. And due to historical reasons, the frequencies used for wireless communication networks tend to differ in the Americas, Europe, and Asia. Thus, there is a wide array of different frequency bands over which wireless communication networks operate.

The frequency bands over which wireless communication networks operate include, but are not limited to, the following:

| Band | Common Name | Region | Frequencies (MHz) |
|---|---|---|---|
| 700 | Seven Hundred Megahertz (SMH) | United | Tx: 698-715 & 777-798 |
| | | States | Rx: 728-756 & 758-768 |
| 800 | Digital Dividend (DD) | Europe | Tx: 791-821 |
| | | | Rx: 832-862 |
| 850 | Evolution-Data Optimized (EV-DO) | Americas | Tx: 824-849 |
| | | | Rx: 869-894 |
| 900 | Primary Global System for Mobile | Europe | Tx: 880-915 |
| | Communications (GSM-900) | | Rx: 925-960 |
| 1700 | Advanced Wireless Services (AWS) | North | Tx: 1710-1755 |
| | | America | Rx: 2110-2170 |
| 1800 | Digital Cellular System (DCS) | Europe & | Tx: 1710-1785 |
| | | Asia | Rx: 1805-1880 |
| 1900 | Personal Communications Service | Americas | Tx: 1850-1910 |
| | (PCS) | | Rx: 1930-1990 |
| 2000 | Universal Mobile Telecom System with | Europe | 1900-1920 & 2010-2025 |
| | Time Division Duplexing (UMTS-TDD) | | |
| 2600 | International Mobile Telecommunications | Europe | Tx: 2500-2570 |
| | Extension (IMT-E) | | Rx: 2620-2690 |

As that list demonstrates, much of the UHF portion of the radio frequency spectrum is occupied by different wireless communication networks, especially with the onset of networks being developed under the Long Term Evolution (LTE) standard at the lower and upper ends of the spectrum (e.g., SMH, DD, and IMT-E networks).

The rapid development of new wireless communication networks has created the need for a variety of base station antenna configurations with a broad range of technical requirements. One of those technical requirements is that the antenna operates across a wide frequency band. The main beam of such an antenna is generally fan shaped—narrow in the elevation plane and wide in the azimuth plane. The beam is wide in the azimuth plane to cover a larger sector and is compressed in the elevation plane to achieve high gain. But as the bandwidth of the antenna increases, physics dictate that the range of values of the azimuth beamwidth will also increase, which results in a large variation in gain response. Thus, antennae that can operate across a wide frequency band have difficulty maintaining a reasonable beamwidth across their full frequency range.

Base station antennae often include vertical linear arrays of microstrip patch radiators. Mircostrip patch radiators include a conductive plate separated from a ground plane by a dielectric medium. In an effort to maintain a reasonable beamwidth in such antennae, it has been discovered that both azimuth beamwidth and beamwidth dispersion can be controlled via parasitic strips disposed in the same plane as the patch radiator (see, e.g., U.S. Pat. No. 4,812,855 to Coe et al.). Similar results have also been achieved by etching slots into the ground plane below the plane of the patch radiator (see, e.g., U.S. Pat. No. 6,320,544 to Korisch et al.). The effects of the etched slots, however, are only minimal when those slots are raised above the ground plane.

Base station antenna may also include vertical linear arrays of crossed dipole radiators. As FIG. 1A illustrates, a crossed dipole radiator 102 includes a pair of dipoles 102A and 102B disposed substantially orthogonal with respect to each other with their center points co-located so as to form the shape of an “X”, or a cross. The crossed dipole radiator 102 is located above a rectangular ground plane 104 in the direction of the z-axis. The ground plane 104 is a conductive plate that is either directly or capacitively coupled to the crossed dipole radiator 102. The pair of dipoles 102A and 102B are positioned at a 45° angle with respect to the longitudinal edges of the ground plane 104 (i.e., the edges of the ground plane 104 parallel with the y-axis) so as to form what is generally known as a cross-polar, or slant-pole, configuration 100. Like patch radiators, crossed dipole radiators 102 and their corresponding ground planes 104 can be arranged in vertical linear arrays with the longitudinal edge of their corresponding ground planes 104 extending vertically (i.e., in the direction of the y-axis) and the lateral edge of their corresponding ground planes 104 extending horizontally (i.e., in the direction of the x-axis).

FIG. 1B illustrates the 3 dB azimuth beamwidth of the slant-pole configuration 100 of FIG. 1A. That azimuth beamwidth is measured for a frequency range of 1700-3000 MHz and a free-space wavelength λ of 135 mm at the mid-band frequency. The azimuth beamwidth varies from 79° to 123° across that frequency range, illustrating a beamwidth dispersion of 44° across that frequency range (123°−79°=44°). In addition, the beamwidth values spike dramatically upward in the higher bands of that frequency range. But in the 1700-2200 MHz frequency range, the beamwidth dispersion is only 3° (82°−79°=3°) and the beamwidth is relatively flat. Accordingly, the slant-pole configuration 100 of FIG. 1A is particularly suited to deploy networks that operate within the 1700-2200 MHz band (e.g., AWS, DCS, and PCS networks). However, as FIG. 1B illustrates, it is not suited for deploying networks in the higher bands (e.g., IMT-E).

As with antenna that include microstrip patch radiators, parasitic strips can also be utilized to improve azimuth beamwidth and beamwidth dispersion in antenna that include crossed dipole radiators. As FIG. 2A illustrates, the resulting single-band array 200 includes parasitic strips 202 disposed on opposing sides of the crossed dipole radiator 102 in the direction of the x-axis. Like the crossed dipole radiator 102, the parasitic strips 202 are disposed at a distance above the ground plane 104 in the direction of the z-axis. The range of frequencies across which that array of elements can operate corresponds to the frequency band in which the crossed dipole radiator 102 is configured to operate. Thus, those elements form what is generally known as a single-band array 200.

In operation, the parasitic strips 202 of the single-band array 200 are excited parasitically by the crossed dipole radiator 102 so that, together, that array of elements forms an electromagnetically coupled resonant circuit that reduces the average value of the azimuth beamwidth and helps make the azimuth beamwidth more compact (i.e., less dispersive). For example, a comparison of FIG. 1B to FIG. 2B illustrates that the parasitic strips 202 lower the beamwidth at almost every frequency across the 1700-3000 MHz range (e.g., from 79° to 66° at 1700 MHz and from 123° to 81° at 3000 MHz) and that the beamwidth dispersion is reduced from 44° (123°−79°=44°) to 15° (81°−66°=15°). Those improvements were observed at a free-space wavelength λ of 135 mm and are a direct result of the parasitic strips 202.

Similar improvements can be obtained using a parasitic enclosure to from an electromagnetically coupled resonant circuit in lieu of using parasitic strips. As FIG. 3A illustrates, the resulting boxed configuration 300 includes a box structure 302 disposed around the crossed dipole radiator 102. The box structure 302 includes four sides 304 that are substantially parallel with the lateral and longitudinal edges of the ground plane 104 and that extend perpendicularly from the ground plane 104 in the direction of the z-axis. The purpose of the box structure is to provide a symmetrical environment for good isolation. And like the parasitic strips 202, the box structure 302 also reduces the average value of the azimuth beamwidth and makes the azimuth beamwidth more compact. For example, a comparison of FIG. 1B to FIG. 3B illustrates that the box structure 302 lowers the beamwidth at almost every frequency across the range (e.g., from 80° to 78° at 1960 MHz and from 123° to 49° at 3000 MHz) and that the beamwidth dispersion is reduced from 44° (123°−79°=44°) to 29° (78°−49°=29°). Those improvements also were observed at a free-space wavelength λ of 135 mm and are a direct result of the parasitic strips 202.

Despite the beamwidth improvements illustrated in FIGS. 2B and 3B, neither the parasitic strips 202 nor the box structure 302 adequately controls azimuth beamwidth and beamwidth dispersion across the entire 1700-3000 MHz frequency range. For example, dramatic spikes in beamwidth still appear toward the extreme ends of that frequency range and the total beamwidth dispersion observed across that frequency range (i.e., 15° and 29°) is still significantly larger than that observed in the 1700-2200 MHz band (i.e., 3°). Moreover, neither the parasitic strips 202 nor the box structure 302 allow azimuth beamwidth and beamwidth dispersion to be controlled in non-continuous frequency ranges (e.g., 695-960 MHz and 1710-2170 MHz).

Those shortcomings of the prior art are particularly troublesome in view of the burgeoning wireless communication networks being developed under the LTE standard. Those networks are slotted to utilize frequencies as low as 698 MHz (e.g., the SMH network) and as high as 2690 MHz (e.g., the IMT-E network). Accordingly, there is a need for a device and/or method for controlling azimuth beamwidth across a wider frequency range.

### SUMMARY OF THE INVENTION

To resolve at least the problems discussed above, it is an object of the present invention to provide a system and method for maintaining a compact azimuth beamwidth in a wide band antenna. The system comprises a first radiating element disposed above a ground plane and one or more parasitic elements disposed proximate to and/or around the first radiating element. Each of the parasitic elements has a slot formed therein that is configured to control beamwidth across a specific frequency range. In one embodiment, the parasitic elements and the slots are configured to control beamwidth across different frequency ranges. And in another embodiment, another parasitic element is disposed within the slots to control beamwidth across another frequency range. Accordingly, the present invention provides a device and method for controlling azimuth beamwidth across a wider frequency range than conventional parasitic strips and enclosures. Those and other objects, advantages, and features of the invention will become more readily apparent when reference is made to the following description, taken in conjunction with the accompanying claims and drawings.

### BRIEF DESCRIPTION OF THE DRAWINGS

Many aspects of the present invention can be better understood with reference to the following drawings, which are part of the specification and represent preferred embodiments of the present invention. The components in the drawings are not necessarily to scale, emphasis instead being placed upon illustrating the principles of the present invention. And, in the drawings, like reference numerals designate corresponding parts throughout the several views.

FIG. 1A is an isometric view illustrating a slant-pole antenna configuration from the related art;

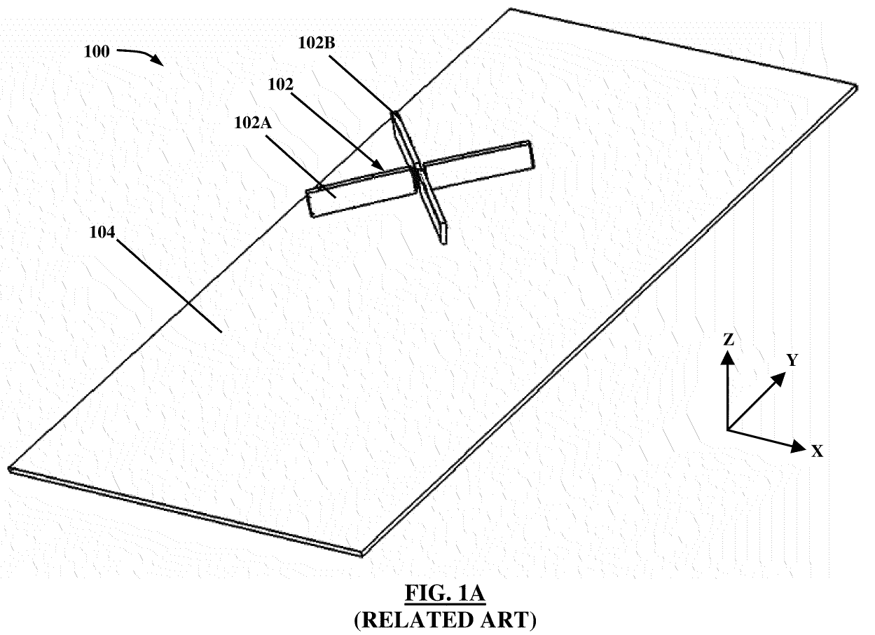

FIG. 1B is a chart illustrating the 3 dB Beamwidth generated by the slant-pole configuration of FIG. 1A across a frequency range of 1700-3000 MHz;

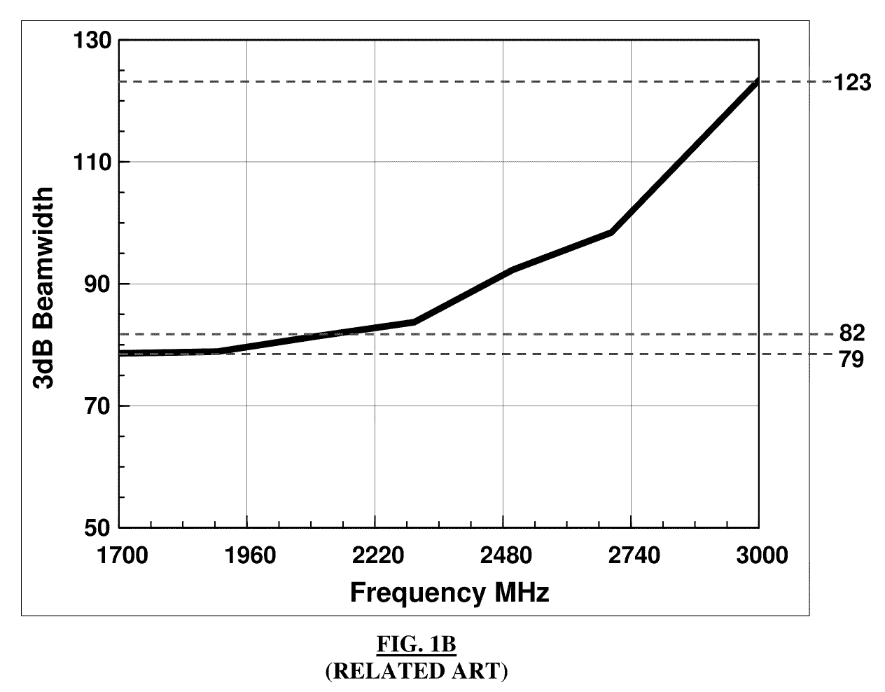

FIG. 2A is an isometric view illustrating a single-band array from the related art;

FIG. 2B is a chart illustrating the 3 dB Beamwidth generated by the single-band array of FIG. 2A across a frequency range of 1700-3000 MHz;

FIG. 3A is an isometric view illustrating a boxed antenna configuration from the related art;

FIG. 3B is a chart illustrating the 3 dB Beamwidth generated by the boxed antenna configuration of FIG. 3A across a frequency range of 1700-3000 MHz;

FIG. 4 is an isometric view illustrating a slotted parasitic strip according to a non-limiting embodiment of the present invention;

FIG. 5A is an isometric view illustrating a single-band array that utilizes the slotted parasitic strip of FIG. 4;

FIG. 5B is a chart illustrating the 3 dB Beamwidth generated by the single-band array of FIG. 5A across a frequency range of 1700-3000 MHz using a first slot length;

FIG. 5C is a chart illustrating the 3 dB Beamwidth generated by the single-band array of FIG. 5A across a frequency range of 1700-3000 MHz using a second slot length;

FIG. 6 is an isometric view illustrating a dual-band array that utilizes the slotted parasitic strip of FIG. 4 according to a non-limiting embodiment of the present invention;

FIG. 7 is an isometric view illustrating a dual-band array that utilizes the slotted parasitic strip of FIG. 4 according to another non-limiting embodiment of the present invention;

FIG. 8A is an isometric view illustrating a boxed configuration that utilizes a modified box structure according to a non-limiting embodiment of the present invention;

FIG. 8B is a chart illustrating the 3 dB Beamwidth generated by the boxed configuration of FIG. 8A across a frequency range of 1700-3000 MHz;

FIG. 9 is a plan view illustrating an angled slot according to a non-limiting embodiment of the present invention;

FIG. 10A is an isometric view illustrating a boxed configuration that utilizes a modified box structure that incorporates the angled slot of FIG. 9;

FIG. 10B is a chart illustrating the 3 dB Beamwidth generated by the boxed configuration of FIG. 10A across a frequency range of 1700-3000 MHz;

FIG. 10C is a chart illustrating the radiation pattern generated by the boxed configuration of FIG. 10A at a frequency of 1700 MHz;

FIG. 10D is a chart illustrating the radiation pattern generated by the boxed configuration of FIG. 10A at a frequency of 2200 MHz;

FIG. 11 is a plan view illustrating the angled slot of FIG. 9 with a parasitic strip disposed therein; and

FIG. 12 is an isometric view illustrating a boxed configuration that utilizes a modified box structure that incorporates the angled slot and parasitic strip of FIG. 11.

### DETAILED DESCRIPTION OF THE PREFERRED EMBODIMENTS

Wireless communication networks currently deployed in the 1700-2200 MHz (e.g., AWS, DCS, and PCS networks) operate with bandwidth a 24%. And when that frequency range is expanded to include networks that operate with frequencies as high as 2690 MHz (e.g., IMT-E networks), the bandwidth increases to 46%. The present invention goes even further by providing a wide bandwidth antenna that maintains a uniform azimuth beamwidth and, therefore, flatter gain response across a 55% bandwidth. In the embodiments described below, that 55% beamwidth is described primarily as being provided by the 2200-3000 MHz frequency range. However, it will be understood by those having ordinary skill in the art that those embodiments can be modified to provide similar performance enhancements in other frequency ranges without departing from the spirit of the present invention.

The technology of the present invention offers great flexibility in antenna sharing, network deployment, and logistic planning. For example, antennae that operate across a large frequency band can accommodate multiple different networks on the same antenna using adjustable electrical down tilt technology, which helps reduce the costs of operating hub stations. Moreover, such antennae help future proof base stations by allowing new networks that operate in different frequency bands to be added, such as the networks currently being developed under the LTE standard (e.g., SMH, DD, and IMT-E networks).

The performance characteristics of the present invention are achieved by providing slotted parasitic strips or slotted parasitic enclosures to control not only azimuth beamwidth, but also beamwidth dispersion, across a very large bandwidth. That control is provided irrespective of whether the parasitic elements are low to the ground plane or elevated high above the ground plane. The present invention achieves the same performance characteristics regardless of the profile of the radiating element. Thus, the present invention can be utilized with substantially any type of antenna arrangement without departing from the spirit of the invention. Several preferred embodiments of the present invention are now described for illustrative purposes, it being understood that the present invention may be embodied in other forms not specifically shown in the drawings.

### Parasitic Strips

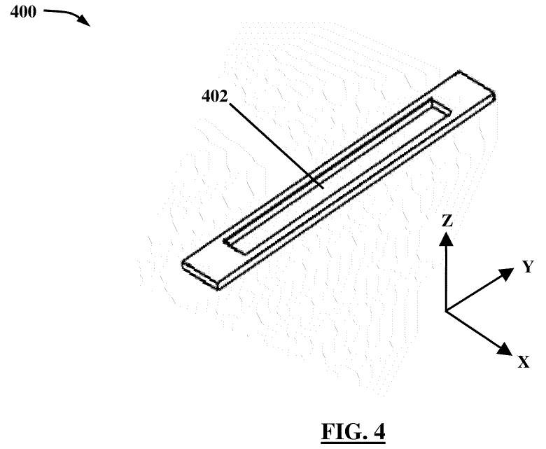

As illustrated in FIG. 4, one preferred embodiment of the present invention utilizes slotted parasitic strips 400 to control azimuth beamwidth and beamwidth dispersion across a wide range of frequencies. Those slotted parasitic strips 400 include rectangular openings, or slots, 402 disposed therein, preferably at a location centered between the lateral and longitudinal edges of the slotted parasitic strip 400. The slots 402 provide an additional degree of control over azimuth beamwidth and beamwidth dispersion by allowing the slotted parasitic strips 400 to generate an additional resonance when excited parasitically by the crossed dipole radiator 102. The additional resonance generated by the slot 402 in the slotted parasitic strips 400 provides control over an additional band within the frequency range in which an antenna is configured to operate. Thus, azimuth beamwidth and beamwidth dispersion can be separately controlled at different bands within that frequency range by changing the length and location of the slotted parasitic strips 400 as well as the length of the slots 402 disposed therein, thereby providing beamwidth control over a larger frequency range.

The slotted parasitic strips 400 and the slots 402 are both preferably ½λ long in the direction of the y-axis, wherein λ is the free-space wavelength at the mid-band frequency of the frequency band over which beamwidth control is sought. And because the length of the slotted parasitic strips 400 is used to control a different frequency band than the length of the slots 402, the value of the free-space wavelength λ will be different for the slotted parasitic strips 400 and the slots 402 (i.e., λ_{L} for the slotted parasitic strips 400 and λ_{H} the slots 402). For example, if the length of the slotted parasitic strips 400 is used to control the 1700-2200 MHz band, their length will be based on a wavelength λ_{L} of 154 mm (i.e., Strip Length=½λ_{L}=½(154 mm)=77 mm). And if the length of the slots 402 is used to control the 2200-3000 MHz band, their length will be based on a wavelength λ_{H} of 130 mm (i.e., Slot Length=½λ_{H}=½(130 mm)=65 mm). As that example demonstrates, longer lengths correspond to lower frequency bands. Thus, because the length of a slot 402 cannot greater than the length of the slotted parasitic strip 400 in which it is disposed, the length of the slotted parasitic strip 400 will generally be used to control lower frequency bands and the length of the slots 402 will generally be used to control upper frequency bands.

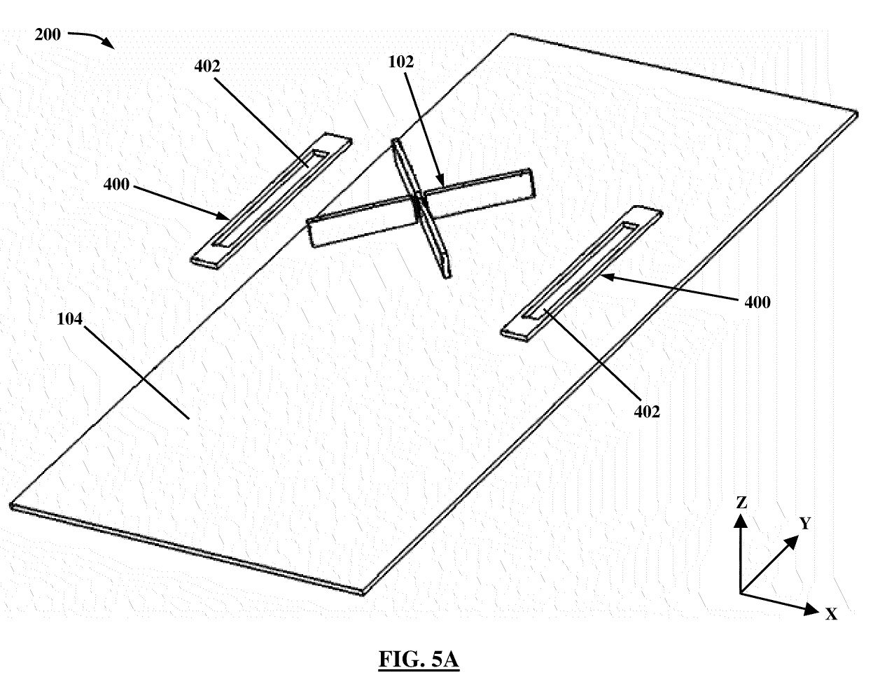

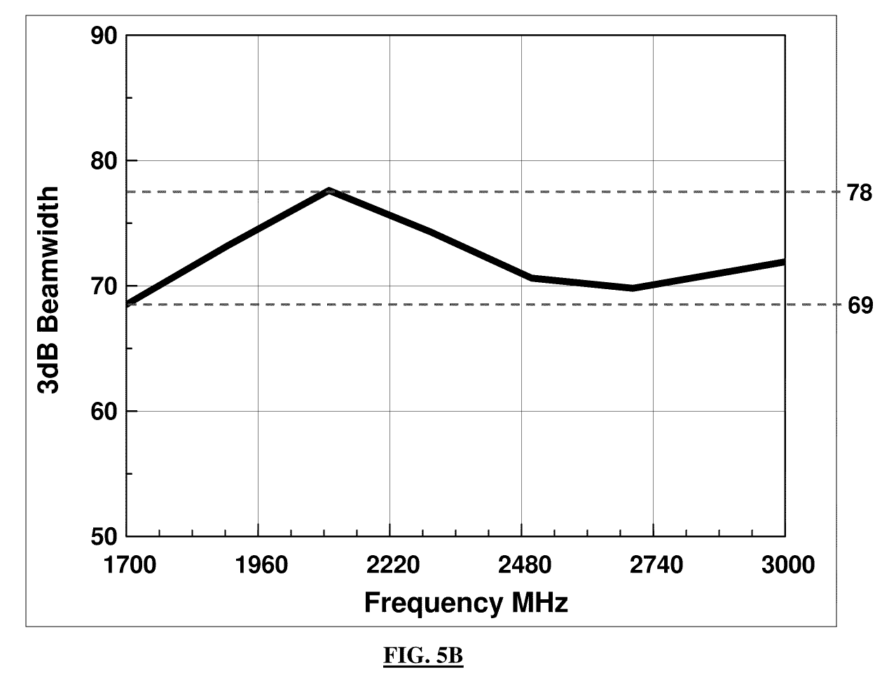

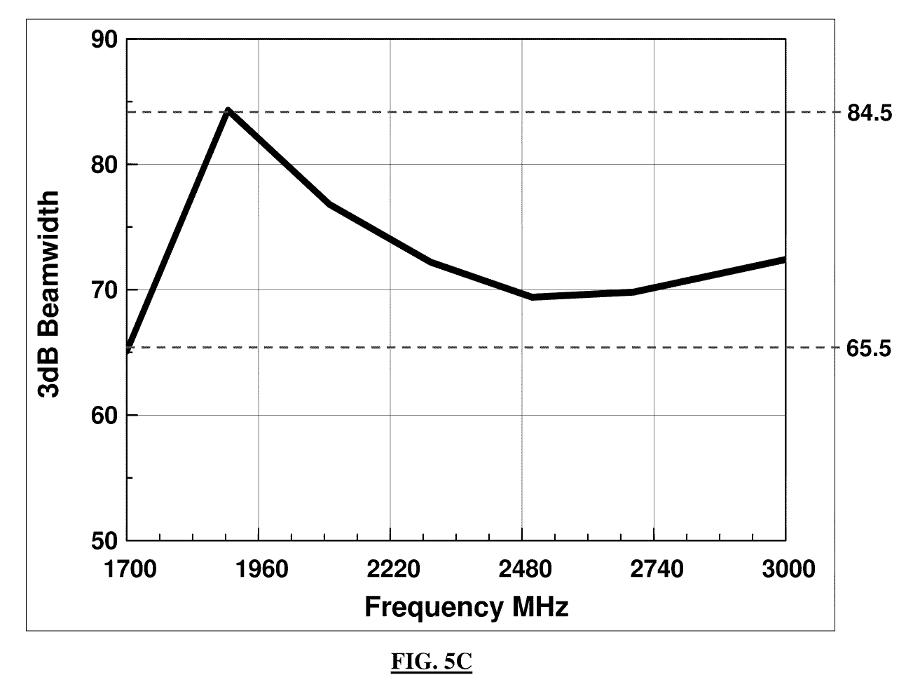

When used in a single-band array 200, as illustrated in FIG. 5A, the slotted parasitic strips 400 are provided as rectangular strips with their respective longitudinal edges (i.e., the edges of the slotted parasitic strips 400 parallel with the y-axis) positioned substantially parallel to the longitudinal edges of the ground plane 104 and with the plane of their largest cross-sectional area substantially parallel to the ground plane 104. The slotted parasitic strips 400 are disposed above the ground plane in the direction of the z-axis, preferably at a distance between 0.15λ_{F} and 0.3λ_{F}, wherein λ_{F} is the free-space wavelength at the mid-band frequency of the full frequency range over which the crossed dipole radiator 102 is configured to operate. And the crossed dipole radiator 102 is preferably disposed above the ground plane a distance of about 0.25λ_{F} in the direction of the z-axis. The slotted parasitic strip 400 can be above, below, or in the same plane as the crossed dipole radiator 102, depending on the structure of the antenna.

The slotted parasitic strips 400 are suspended above the ground plane 104 using a dielectric spacer (not shown), such as foam insulation, so they are not electrically coupled to the ground plane 104. And the crossed dipole radiator 102 is suspended above the ground plane 104 with a standoff (not shown) that allows a direct electrical connection (e.g., via an electrical wire) to the ground plane 104 or that allows the crossed dipole radiator 102 to capacitively couple with the ground plane 104 (e.g., by separating the ground plane and the crossed dipole radiator 102 with a thin insulator). The standoff itself may also serve as the direct electrical connection to the ground plane 104. The crossed dipole radiator 102 and slotted parasitic strips 400 are formed from a thin metal sheet or a printed circuit board (PCB) and can be formed by any suitable process (e.g., stamping, milling, plating, etching, etc.).

The longitudinal edges of the slotted parasitic strips 400 are centered with the central portion of the crossed dipole radiator 102 in the direction of the y-axis so that their central portions are co-linear in the direction of the x-axis, preferably within ±0.3λ_{F}. The slotted parasitic strips 400 are located close to the crossed dipole radiator 102 in the direction of the x-axis, preferably at a distance between 0.3λ_{F} and 0.5λ_{F} from the central portion of crossed dipole radiator 102. That dimension allows the antenna to be made small, which is an attribute that many base station operators demand. Each dipole 102A and 102B of the crossed dipole radiator 102 is preferably about ½λ_{F} long along its longitudinal edge (i.e., the edge at a 45° angle with respect to the longitudinal edges of the ground plane 104). Each dipole 102A and 102B may also be slightly longer or slightly shorter than ½λ_{F}, depending on the environment in which the crossed dipole radiator 102 is configured to operate. The ground plane 104 is a conductive plate that is preferably about 1λ_{F} wide along its lateral edge (i.e., the edge parallel with the x-axis).

The configuration described above is intended to yield an average azimuth beamwidth of about 65°, which provides optimum performance for the most common requirements utilized by wireless communication networks. However, that average value can vary anywhere between 33° and 120°. And although the slotted parasitic strips 400 and their slots 402 are described as being rectangular, they may be of any suitable shape required to resonate the signals of the crossed dipole radiator 102 in the desired manner.

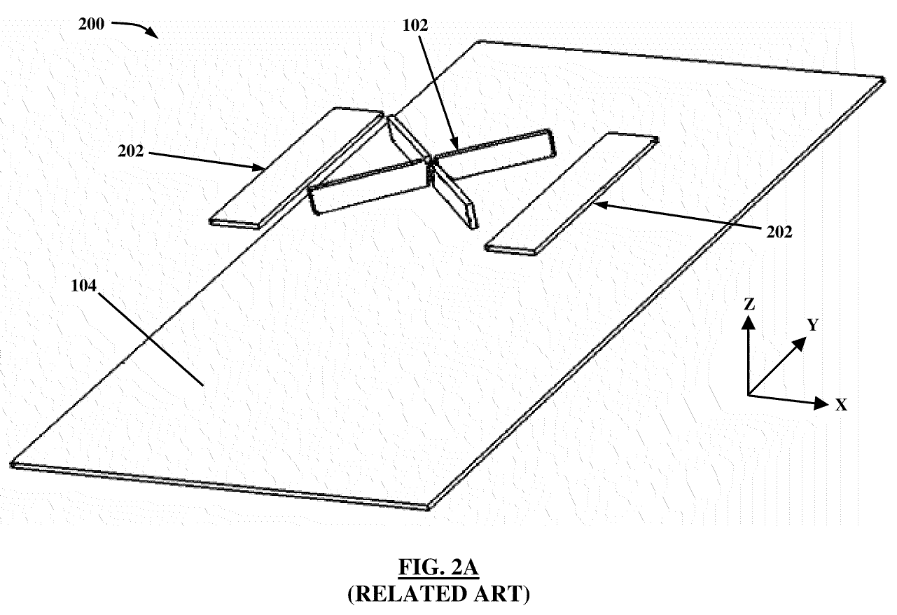

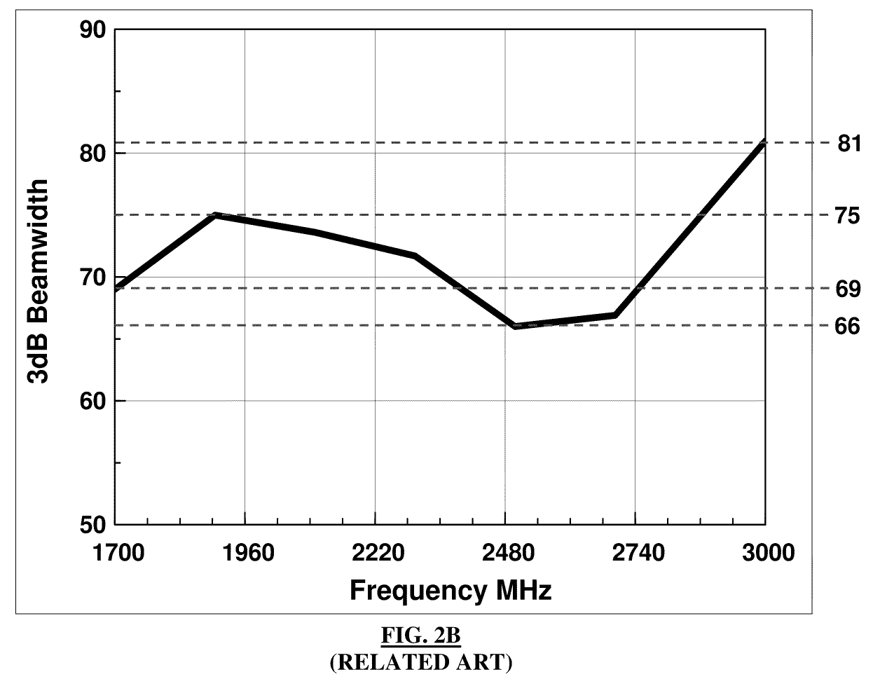

The additional degree of control provided by the slots 402 in the slotted parasitic strips 400 in the single-band array 200 of FIG. 5A provide better performance characteristics than the parasitic strips 202 in the single-band array 200 of FIG. 2A. In operation, both the outside edges of the slotted parasitic strips 400 and the edges of the slots 402 are excited parasitically by the crossed dipole radiator 102 so that they resonate at different frequencies. The additional resonance generated by the slot 402 in the slotted parasitic strips 400 provides control over an additional band within the frequency range over which the crossed dipole radiator 102 is configured to operate. Thus, as discussed above, different bands can be controlled by changing the length and location of the slotted parasitic strips 400 as well as the length and location of the slots 402 disposed therein.

By way of illustrative example, the length of the slotted parasitic strips 400 can be adjusted to maintain low dispersion in the 1700-2200 MHz band while the length of the slots 402 is adjusted to further reduce dispersion in the 2200-3000 MHz band. As FIG. 5B illustrates, adjusting the slotted parasitic strips 400 and slots 402 in the single-band array 200 of FIG. 5A in that manner reduces azimuth bandwidth and bandwidth dispersion compared to the conventional parasitic strips 202 of the single-band array 200 of FIG. 2A. In particular, the length of the slots 402 further reduces dispersion in the 2200-3000 MHz band. Accordingly, a comparison of FIG. 2B to FIG. 5B illustrates that the azimuth bandwidth is not only flattened within the 1700-3000 MHz frequency range, but that dispersion is reduced from 15° (81°−66°=15°) to 9° (78°−69°=9°) across that frequency range. The slotted parasitic strips 400 of the single-band array 200 of FIG. 5A thereby maintain flatter gain response across the 1700-2200 MHz band than the conventional parasitic strips 202 of the single-band array 200 of FIG. 2A.

To obtain the results illustrated in FIG. 5B, the length of the slotted parasitic strips 400 was based on a wavelength λ_{L} of 154 mm for the 1700-2200 MHz band (i.e., Length=½λ_{L}=½(154 mm)=77 mm), and the length of the slots 402 was based on a wavelength λ_{H} of 130 mm for the 2200-3000 MHz band (i.e., Length=½λ_{H}=½(130 mm)=65 mm). And by increasing the length of the slots 402, they can also be used to affect the 1700-2200 MHz band, as illustrated in FIG. 5C. To obtain the results illustrated in FIG. 5C, the length of the slots 402 was based on a wavelength λ_{H} of 150 mm (i.e., Length=½λ_{H}=½(150 mm)=75 mm). That ability to control lower bands with the slots 400 is particularly suited for use in dual-band arrays.

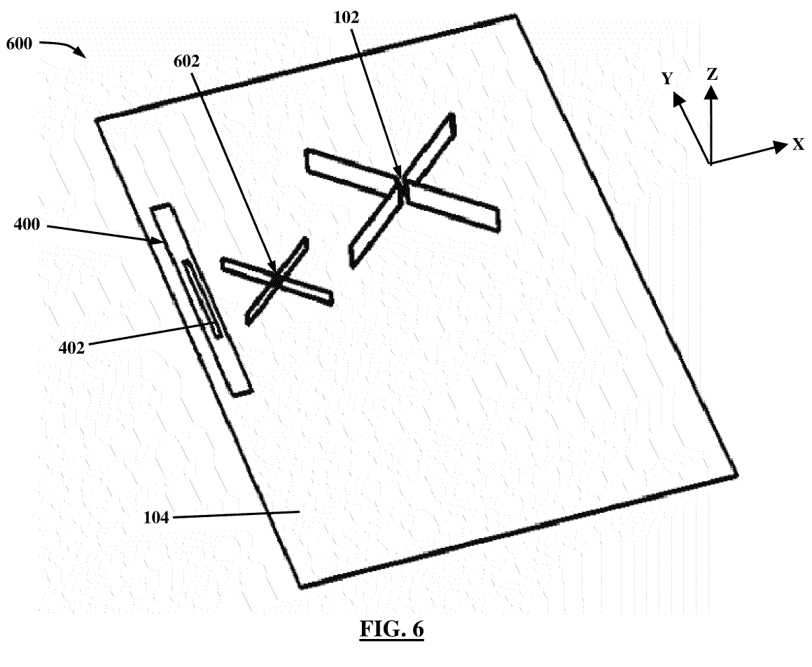

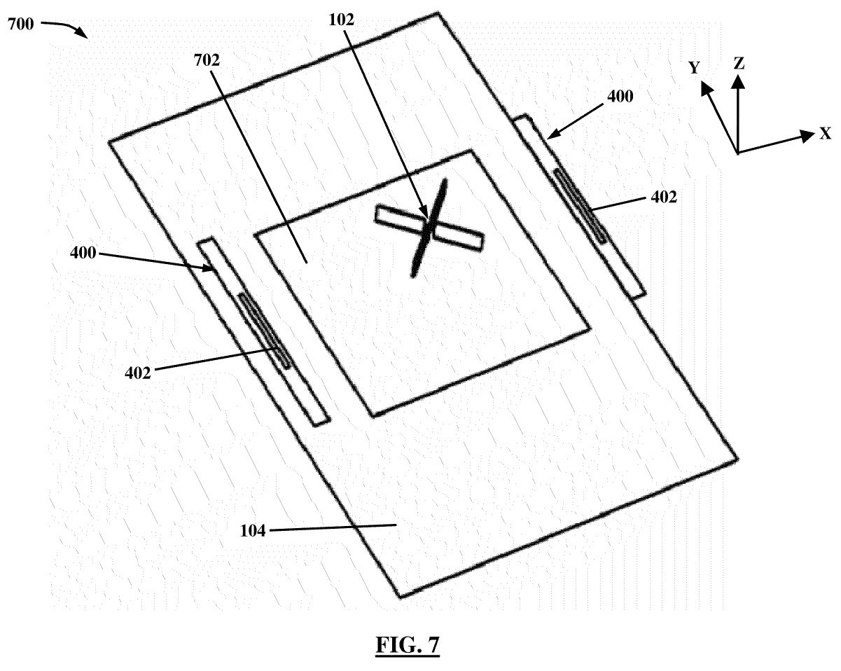

Dual-band arrays utilize two separate radiator elements that are configured to operate within two separate frequency ranges. As FIG. 6 illustrates, a dual-band array 600 may include two separate crossed dipole radiators 102 and 602 configured to operate within two separate frequencies ranges (e.g., 695-960 MHz and 1710-2700 MHz). Or as FIG. 7 illustrates, a dual-band array 700 may include a low frequency band patch 702 configured to operate within a low frequency range (e.g., 695-960 MHz) and a crossed dipole radiator 102 configured to operate within a high frequency range (e.g., 1710-2700 MHz). In the dual-band array 600 of FIG. 6, the crossed dipole radiator 102 that is configured to operate within the higher frequency range is disposed between the other crossed dipole radiator 602 and a slotted parasitic strip 400 in the direction of the x-axis. And in the dual-band array 700 of FIG. 7, the low frequency band patch 702 is disposed between the crossed dipole radiator 102 and the ground plane 104 in the direction of the z-axis such that the low frequency band patch 702 acts as a ground plane or reflector for the crossed dipole radiator 102. Also in the dual-band array of FIG. 7, the low frequency band patch 702 and the crossed dipole radiator 102 are disposed between a pair of slotted parasitic strips 400 in the direction of the x-axis.

As with the single-band array 200 of FIG. 5A, the lengths of the slotted parasitic strips 400 and their corresponding slots 402 are determined based on the frequency range over which they are meant to provide control in the dual-band arrays 600 and 700 illustrated in FIGS. 6 and 7, respectively. And because the slots 402 cannot be longer than the slotted parasitic strip 400, the slots 402 are configured to control the higher frequency ranges while the slotted parasitic strips 400 are configured to control the lower frequency ranges. For example, using the exemplary frequencies described above with respect to the dual-band arrays 600 and 700 illustrated in FIGS. 6 and 7, each slotted parasitic strip 400 has a length based on a wavelength λ_{L} of 360 mm for the 695-960 MHz frequency range (i.e., Length=½λ_{L}=½(360 mm)=180 mm) and each slot 402 has a length based on a wavelength λ_{H} of 136 mm for the 2170-2700 MHz band (i.e., Length=½λ_{H}=½(136 mm)=68 mm).

When used in a dual-band array 600 or 700 as described, the slotted parasitic strips 400 and their corresponding slots 402 provide control over azimuth beamwidth and beamwidth dispersion in two separate frequency bands in a similar manner to that discussed above with respect to a single, continuous frequency band and the single-band array 200. Thus, the slotted parasitic strips 400 of the present invention can be used not only to improve performance characteristics across a wider frequency range in a single-band array (e.g., 2200-3000 MHz), they can also be used to improve performance characteristics across different frequency ranges in dual-band arrays (e.g., 695-960 MHz and 1710-2700 MHz). Accordingly, the slotted parasitic strips 400 of the present invention control azimuth beamwidth and beamwidth dispersion across a wider bandwidth (e.g., a 55% bandwidth) than could previously be achieved by conventional parasitic strips 202. That functionality is particularly useful in view of the burgeoning wireless communication networks being developed in the lower bands and upper bands of the UHF portion of the radio frequency spectrum under the LTE standard (e.g., the SMH, DD, and IMT-E networks).

### Parasitic Enclosure

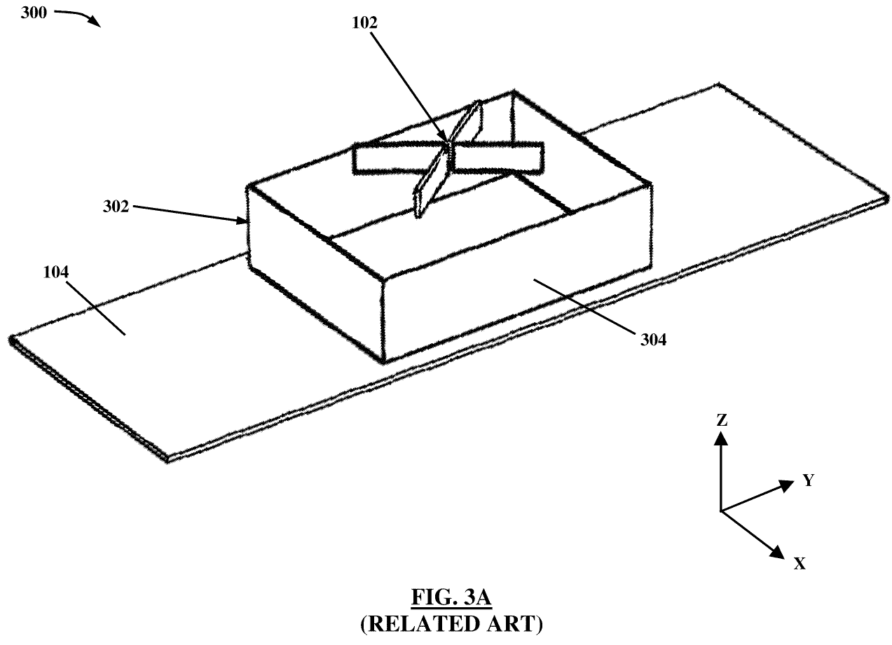

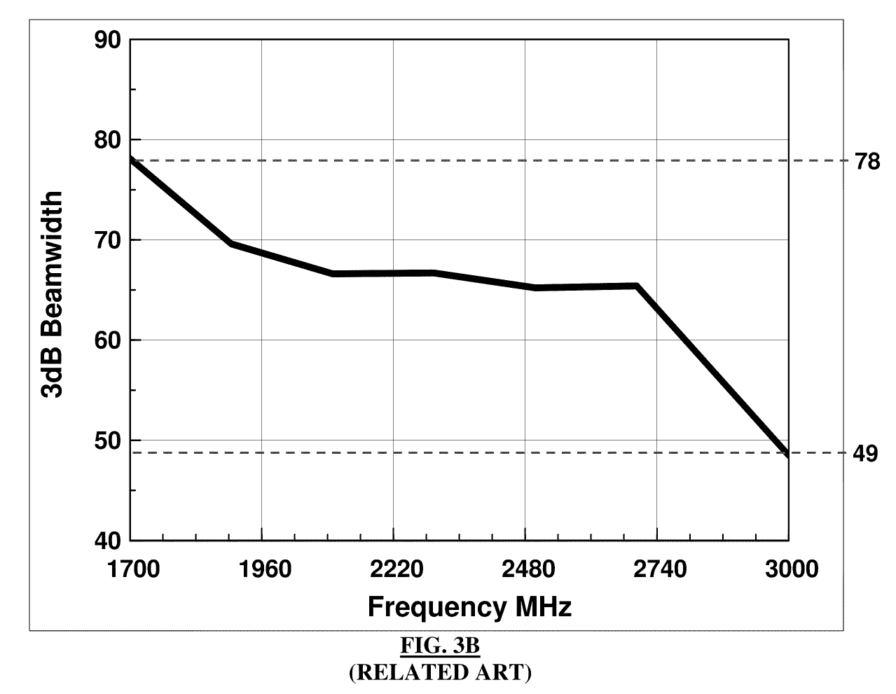

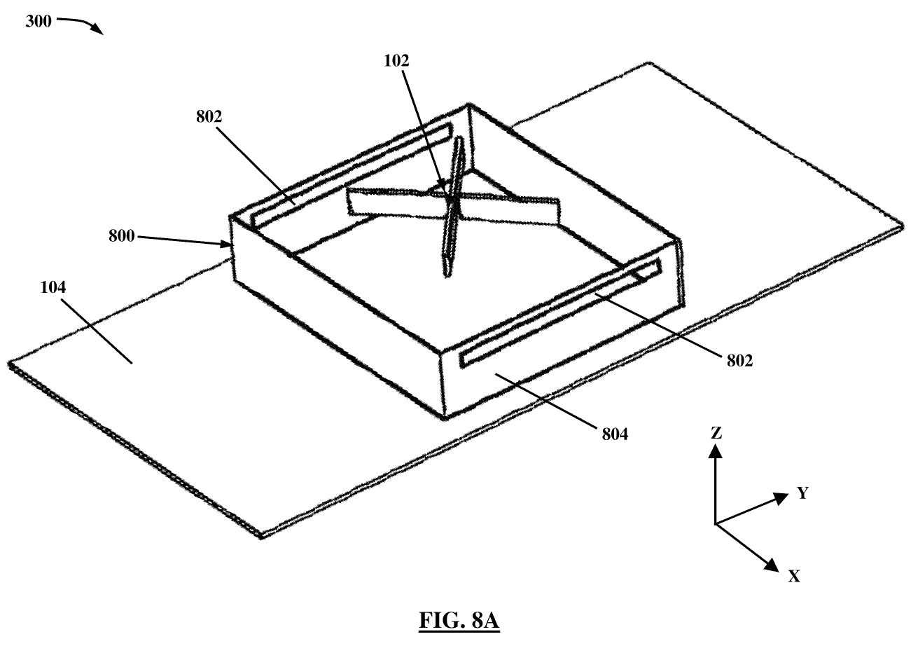

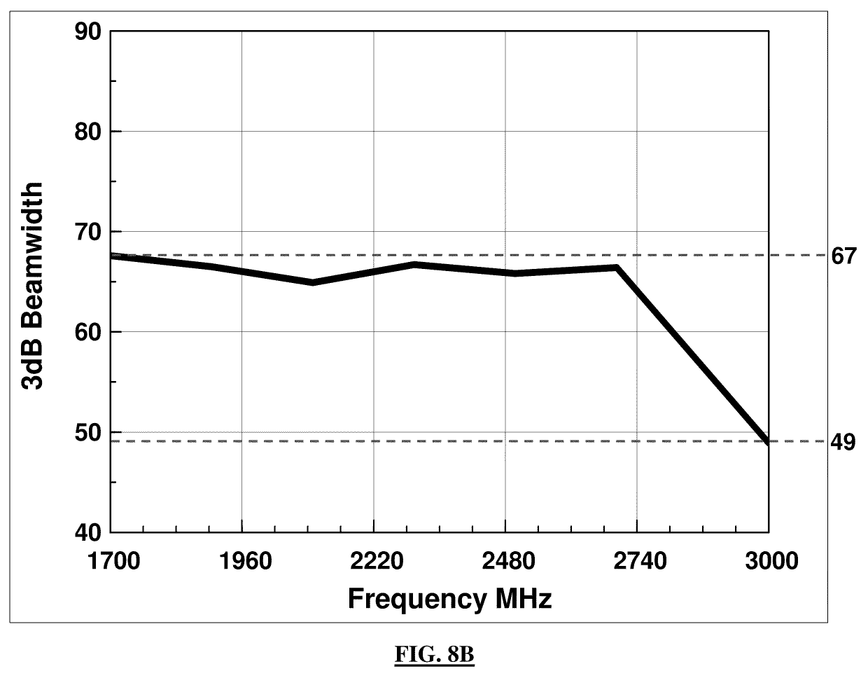

As discussed above, some base station antennae utilize a boxed configuration 300, wherein the radiating element 102 is surrounded by a conductive box structure 302. Although such structures allow some degree of control over beamwidth through changes in the width and height of the box structure 302, conventional box structures 302 are not capable of providing compact beamwidth values across a wide bandwidth (e.g., a 55% bandwidth). As FIGS. 8A-12 illustrate, another preferred embodiment of the present invention improves upon the performance characteristics of the conventional boxed structure 302 of FIG. 3A by providing a modified box structure 800 that includes horizontal openings, or slots, 802 formed in opposite sides 804 thereof.

As FIGS. 8A and 8B illustrate, the boxed configuration 300 of the present invention utilizes a square box structure 800 connected to the ground plane 104. The box structure 800 includes four sides 804 that are substantially parallel with the lateral and longitudinal edges of the ground plane 104 in the directions of the z-axis and y-axis and that extend substantially perpendicular from the ground plane 104 in the direction of the z-axis. The modified box structure may be formed from a thin metal sheet or a PCB and can be formed by any suitable process (e.g., stamping, milling, plating, etching, etc.). The crossed dipole radiator 102 is disposed between the sides 804 of the box structure 800 so that it is surrounded on four sides by the box structure. The crossed dipole radiator 102 may be enclosed within the box structure 800 by a radome (not shown) so as to shield the crossed dipole radiator 102 and other antenna components within the box structure 800 from the elements.

The horizontal slots 802 are disposed in the sides 804 of the box structure 800 on opposite sides of the crossed dipole radiator 102. The horizontal slots 802 are disposed in the sides 804 of the box structure 800 with their largest cross-sectional area substantially perpendicular to the ground plane 104 and substantially parallel to the longitudinal edges of the ground plane 104. Although the horizontal slots 802 are illustrated as rectangular, they may be of any suitable shape required to resonate the signals of the crossed dipole radiator 102 in the desired manner. Similarly, although the box structure 800 is illustrated as square and as enclosing a cross dipole radiator 102, other shaped box structures and other radiators may also be used to obtain different performance characteristics.

As illustrated, the sides 804 of the box structure 800 are substantially equal in length, preferably each about 0.77λ_{F} long. Each dipole 102A and 102B of the crossed dipole radiator 102 is preferably about ½λ_{F} long along its longitudinal edge (i.e., the edge at a 45° angle with respect to the longitudinal edges of the ground plane 104). Each dipole 102A and 102B may also be slightly longer or slightly shorter than ½λ_{F}, depending on the environment in which the crossed dipole radiator 102 is configured to operate. And the horizontal slots 802 are preferably ½λ_{F} in length along their longitudinal edges so as to better resonate the signals generated by the crossed dipole radiator 102. That configuration is intended to yield an average azimuth beamwidth of about 70°±6° in the frequency range of 1710-2170 MHz.

The horizontal slots 802 are provided in the longitudinal sides 804 of the box structure 800 (i.e., the sides parallel to the y-axis) so as to create an array of elements in the direction of the x-axis. Horizontal slots 802 may also be provided in the lateral sides 804 of the box structure 800 (i.e., the sides parallel to the x-axis). But because the boxed configurations 800 are provided in vertical linear arrays along the y-axis in a hub station antenna, the influence of horizontal slots 802 disposed in the lateral sides 804 of the box structure 800 will not be as dominant as the influence of horizontal slots 802 disposed in the longitudinal sides 804 of the box structure 800. Thus, horizontal slots 802 generally are not utilized in the lateral sides 804 of the box structure 800.

As with the conventional parasitic elements 200 discussed above, the horizontal slots 802 of the modified box structure 800 add a degree of control over azimuth beamwidth and beamwidth dispersion in the boxed configuration 300 such that, by changing the length and location of the horizontal slots 802, the average value of the azimuth beamwidth and the beamwidth dispersion can be affected at different bands within the frequency range of an antenna. For example, a comparison of FIG. 3B to FIG. 8B illustrates that the horizontal slots 802 lower the beamwidth at several frequencies (e.g., from 80° to 67° at 1700 MHz) and that the beamwidth dispersion is reduced from 29° (78°−49°=29°) to 18° (67°−49°=18°). Those improved characteristics are a direct result of optimizing the length of the horizontal slots 802 to resonate at 1700-2200 MHz band of the 1700-3000 MHz frequency range.

The horizontal slots 802 of the present invention improve azimuth bandwidth and beamwidth dispersion in the boxed configuration 300 of FIG. 8A without compromising several other key operating characteristics, such as the Voltage Standing Wave Ratio (VSWR), isolation, gain, and pattern shaping. However, the horizontal slots 802 cause some unwanted radiation to be transmitted at the rear of that configuration, which increases the front-to-back ratio of the main lobe. The front-to-back ratio is defined as the power ratio of the main lobe's front and back. Thus, a higher front-to-back ratio means that more unwanted radiation is being transmitted at the back of the main lobe (i.e., the rear of the boxed configuration 300). Poor azimuth roll-off also results from energy being radiated in an unwanted direction.

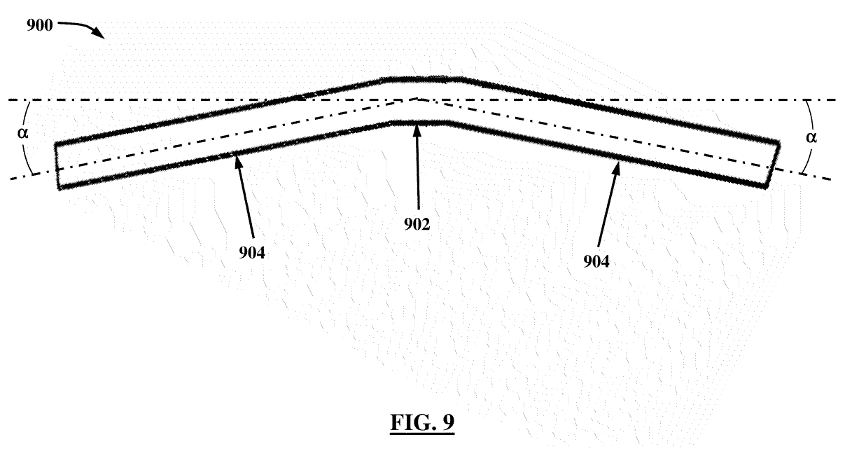

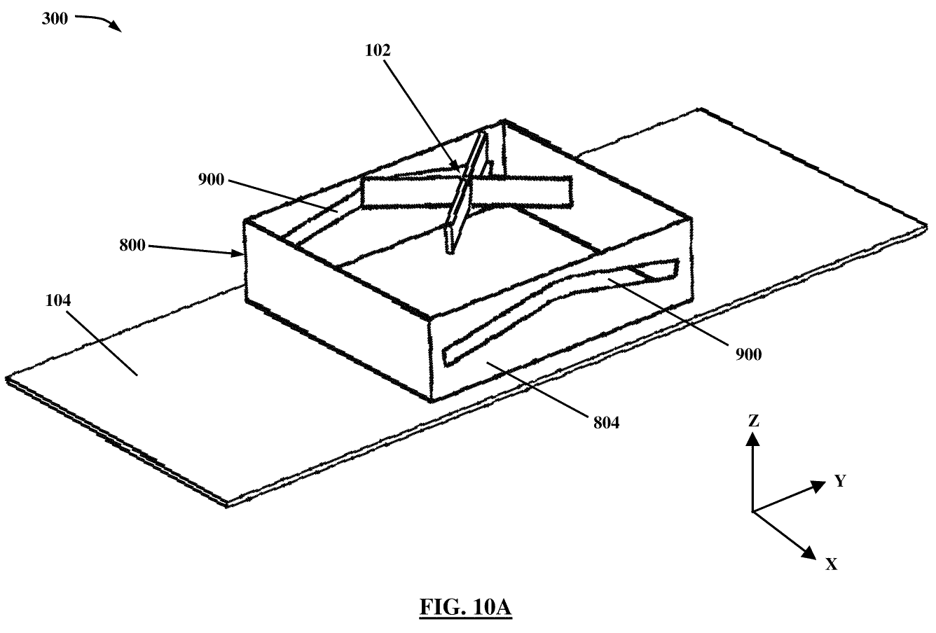

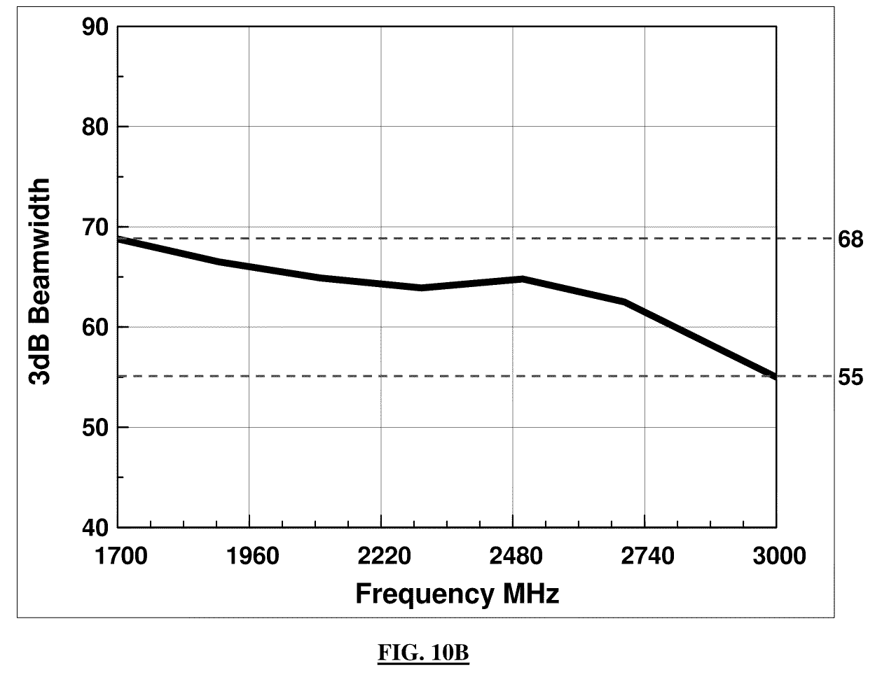

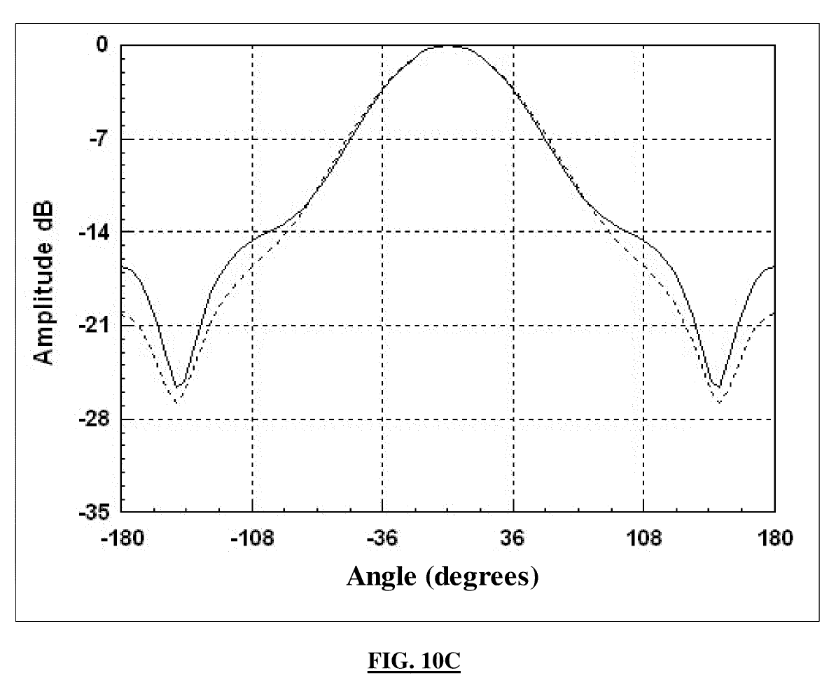

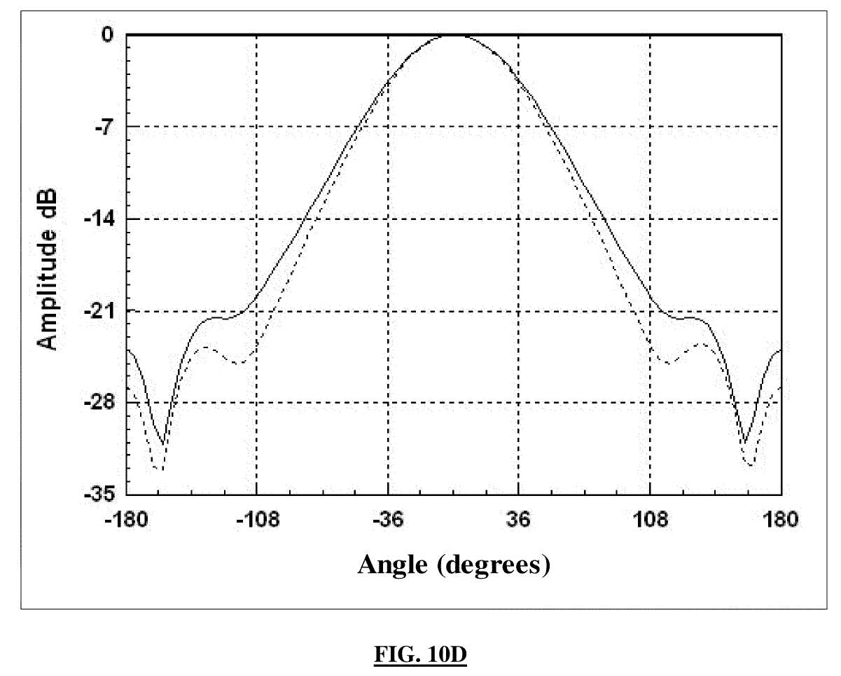

The present invention provides improved front-to-back ratio and better azimuth roll-off by replacing the horizontal slots 802 in the modified box structure 800 of FIG. 8A with the angled slots 900 illustrated in FIG. 9. Like the horizontal slots 802 in the modified box structure 800 of FIG. 8A, the angled slots 900 in the modified box structure 800 of FIG. 10A are disposed in the sides 804 of the box structure 800 on opposing sides of the crossed dipole radiator 102 so as to create a lateral array of elements. Also like the horizontal slots 802 in the modified box structure 800 of FIG. 8A, the angled slots 900 in the modified box structure 800 of FIG. 10A are disposed in the lateral sides 804 of that structure with their largest cross-sectional area substantially perpendicular to the ground plane 104 and substantially parallel to the lateral edges of the ground plane 104. But instead of being rectangular like the horizontal slots 802, the angled slots 900 are angled downward in the direction of the y-axis at their distal ends so as to substantially form the shape of an upside down, flattened “V”, or a boomerang.

As FIG. 9 illustrates, the angled slots 900 include a central portion 902 with a pair of arms 904 extending from opposing sides of the central portion 902 at an angle α. The central portion 902 extends substantially parallel to the ground plane 104 in the direction of the y-axis, and the angle α is taken with respect to the y-axis. That angle α must be adjusted to optimize the front-to-back ratio and azimuth roll-off as the size of the modified box structure and the location of the angled slots 900 changes, including using negative angles α in some instances such that the angled slots 900 substantially form the shape of a right-side-up, flattened “V”. In the configuration illustrated in FIG. 10A, the angle of the angled slots 900 has been optimized at 11° for the 1700-2200 MHz band.

The angled slots 900 in the modified box structure 800 of FIG. 10A maintain the improved azimuth beamwidth and beamwidth dispersion achieved by the horizontal slots 802 in the modified box structure 800 of FIG. 8A while also improving front-to-back ratio and azimuth roll-off. For example, a comparison of FIG. 3B to FIG. 10B illustrates that the angled slots 900 lower the beamwidth at several frequencies (e.g., from 78° to 68° at 1700 MHz) and that the beamwidth dispersion is reduced from 29° (78°−49°=29°) to 13° (68°—55°=13°). And as FIGS. 10C and 10D illustrate, the angled slots 900 also reduce front-to-back ratio and azimuth roll-off.

FIGS. 10C and 10D illustrate the radiation patterns generated by the modified box structure 800 of FIG. 8A and the modified box structure 800 of FIG. 10A. The radiation patterns generated by the horizontal slots 802 in the modified box structure 800 of FIG. 8A are represented as a solid line, and the radiation patterns generated by the angled slots 900 in the modified box structure 800 of FIG. 10A are represented as a dashed line. FIG. 10C illustrates those radiation patterns at 1700 MHz, and FIG. 10D illustrates those radiation patterns at 2200 MHz. In both figures, the 3 dB bandwidth is the same. And the improved performance characteristics are clearly demonstrated within the 180°±10° power level in both figures. Those improved performance characteristics are a direct result of angling the distal ends of the angled slots 900.

The improved performance characteristics provided by the horizontal slots 802 in the modified box structure 800 of FIG. 8A and the angled slots 900 in the modified box structure 800 of FIG. 10A can be improved even further by adding a parasitic strip within those slots. As with the slots 402 in the slotted parasitic strips 400 discussed above, the addition of a parasitic strip to the horizontal slots 802 in the modified box structure 800 of FIG. 8A or the angled slots 900 in the modified box structure 800 of FIG. 10A adds yet another degree of control over azimuth beamwidth and beamwidth dispersion. In particular, the parasitic strip allows azimuth beamwidth and beamwidth dispersion to be controlled across a wider frequency range.

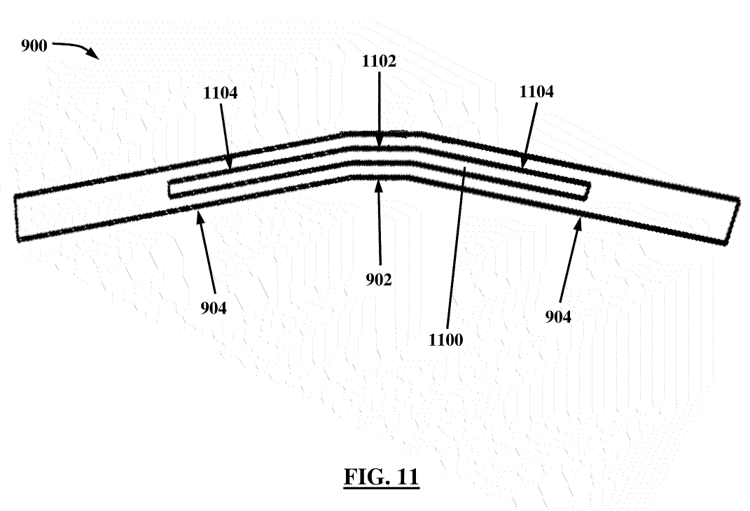

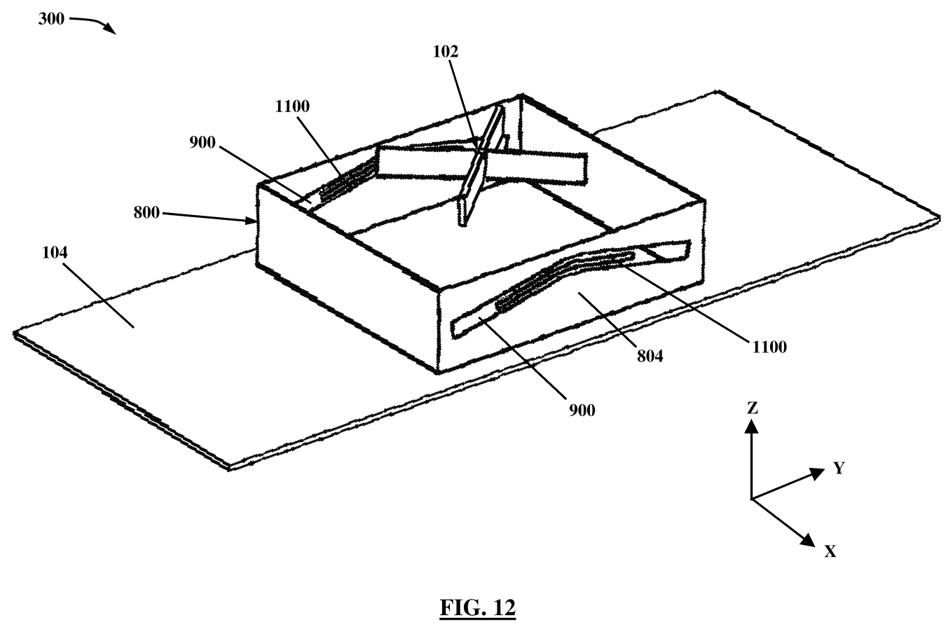

FIGS. 11 and 12 illustrate the modified box structure 800 of FIG. 10A further modified to include an angled parasitic strip 1100 disposed within the angled slots 900. The angled parasitic strips 1100 are preferably disposed within the angled slots 900 at a location centered between the lateral and longitudinal edges of the angled slots 900. As FIG. 11 illustrates, the angled parasitic strips 1100 include a central portion 1102 with a pair of arms 1104 extending from opposing sides of the central portion 1102 at the same angle α as the arms 904 of the angled slots 900 so there is substantially equal clearance between the angled parasitic strips 1100 and the angled slots 900 above and below the angled parasitic strips 1100 (i.e., in the direction of the z-axis). The same clearance would also be desired for rectangular parasitic strips (not shown) disposed in the horizontal slots 802.

The angled parasitic strips 1100 provide an additional degree of control over azimuth beamwidth and beamwidth dispersion by generating an additional resonance when they are excited parasitically by the crossed dipole radiator 102. Accordingly, just as discussed above with respect to FIGS. 4-7, the respective lengths of the angled slots 900 and angled parasitic strips 1100 can be changed as required to control different bands within the frequency band in which the crossed dipole radiator 102 is configured to operate. And their angle α can be adjusted to reduce front-to-back ratio and azimuth roll-off.

The angled slots 900 and their respective angled parasitic strips 1100 provide substantially the same functionality as described above with respect to the slotted parasitic strips 400 and their respective slots 402. However, because the angled parasitic strips 1100 are disposed within the angled slots 900, the length of the angled parasitic strips 1100 cannot be larger than the length of the angled slots 900. Accordingly, in the embodiment illustrated in FIG. 12, the length of the angled slots 900 will generally be used to control lower frequency bands and the length of the angled parasitic strips 1100 will generally be used to control upper frequency bands. Thus, instead of having a length based on the free-space wavelength λ_{F} at the mid-band frequency of the full frequency range over which the crossed dipole radiator 102 is configured to operate, the angled slots 900 and angled parasitic strips 1100 will have lengths based on the frequency ranges over which they will control azimuth beamwidth and beamwidth dispersion (e.g., λ_{L} for the angled slots 900 and low frequency bands and λ_{H} for the angled parasitic strips 1100 and high frequency bands).

The additional degree of control provided by such angled parasitic strips 1100 not only allows the modified box structure 800 of FIG. 12 to control azimuth beamwidth and beamwidth dispersion over a wider bandwidth in a single-band array, it also provides control over azimuth beamwidth and beamwidth dispersion in two separate frequency bands in a similar manner to that discussed above with respect to the dual-band arrays 600 and 700 of FIGS. 6 and 7 (e.g., 695-960 MHz and 1710-2700 MHz). Accordingly, the boxed configuration 300 of FIG. 12 can be modified as required to accommodate such dual-band arrays. That functionality is particularly useful in view of the burgeoning wireless communication networks being developed in the lower bands and upper bands of the UHF portion of the radio frequency spectrum under the LTE standard (e.g., the SMH, DD, and IMT-E networks).

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. For example, although the present invention is described primarily with respect to operating in the 1700-3000 MHz frequency range, it can also be utilized with similar results in other frequency ranges by scaling. It can also be used with antenna configurations other than the slant-pole configurations described above. Accordingly, it is intended that the invention be limited only to the extent required by the appended claims and the applicable rules of law.

What is claimed is:

1. A wide band antenna with a compact azimuth beamwidth, the antenna comprising:
a ground plane;
a first radiating element disposed above the ground plane; and
a box structure disposed around the first radiating element having horizontal openings on opposing sides of the radiating element, the horizontal openings being configured to control beamwidth across a first frequency range.

2. The antenna of claim 1, wherein the horizontal openings include a horizontal central portion and a pair of arms extending from opposing sides of the central portion at an angle, the angle being chosen so as to reduce a front-to-back ratio of the antenna.

3. The antenna of claim 2, further comprising a parasitic strip disposed centrally in each of the horizontal openings, the parasitic strip being dimensioned to control beamwidth across a second frequency range.

4. The antenna of claim 3, wherein the parasitic strips include a horizontal central portion and a pair of arms extending from opposing sides of the central portion at the angle.

5. The antenna of claim 3, wherein the first and second frequency range are included in a third frequency range over which the first radiating element is configured to operate.

6. The antenna of claim 1, further comprising a parasitic strip disposed in each of the horizontal openings, the parasitic strips being dimensioned to control beamwidth across a second frequency range.

7. The antenna of claim 6, wherein the first and second frequency range are included in a third frequency range over which the first radiating element is configured to operate.

8. The antenna of claim 6, further comprising a second radiating element disposed within the box structure, the first radiating element being configured to operate within the first frequency range and the second radiating element being configured to operate within the second frequency range.

9. The antenna of claim 6, further comprising a low frequency band patch disposed in the box structure between the ground plane and the first radiating element, the low frequency band patch being configured to operate within the first frequency range and the first radiating element being configured to operate within the second frequency range.

10. The antenna of claim 6, wherein the first frequency range and the second frequency cover a 55% bandwidth.

11. A method for providing a compact azimuth beamwidth in a wide band antenna comprising the steps of:
installing a first radiating element above a ground plane;
disposing a box structure around the first radiating element; and
providing horizontal openings in opposing sides of the radiating element, the horizontal openings being configured to control beamwidth across a first frequency range.

12. The method of claim 11, wherein the horizontal openings include a horizontal central portion and a pair of arms extending from opposing sides of the central portion at an angle, the angle being chosen so as to reduce a front-to-back ratio of the antenna.

13. The method of claim 12, further comprising the step of providing a parasitic strip at a central location in each of the horizontal openings, the parasitic strip being dimensioned to control beamwidth across a second frequency range.

14. The method of claim 13, wherein the parasitic strips include a horizontal central portion and a pair of arms extending from opposing sides of the central portion at the angle.

15. The method of claim 13, wherein the first and second frequency range are included in a third frequency range over which the first radiating element is configured to operate.

16. The method of claim 11, further comprising the step of providing a parasitic strip at a central location in each of the horizontal openings, the parasitic strip being dimensioned to control beamwidth across a second frequency range.

17. The method of claim 16, wherein the first and second frequency range are included in a third frequency range over which the first radiating element is configured to operate.

18. The method of claim 16, further comprising the step of disposing a second radiating element within the box structure, the first radiating element being configured to operate within the first frequency range and the second radiating element being configured to operate within the second frequency range.

19. The method of claim 16, further comprising the step of disposing a low frequency band patch in the box structure between the ground plane and the first radiating element, the low frequency band patch being configured to operate within the first frequency range and the first radiating element being configured to operate within the second frequency range.

20. The method of claim 16, wherein the first frequency range and the second frequency cover a 55% bandwidth.

21. A wide band antenna with a compact azimuth beamwidth, the antenna comprising:
a ground plane;
a first radiating element disposed above the ground plane; and
one or more parasitic elements disposed proximate to the first radiating element, each of said one or more parasitic elements having a slot formed therein,
wherein each parasitic element is configured to control beamwidth across a first frequency range and each slot is configured to control beamwidth across a second frequency range.

22. The antenna of claim 21, wherein the one or more parasitic elements are substantially rectangular.

23. The antenna of claim 22, wherein the slot in each of the one or more parasitic elements is substantially rectangular and disposed at a central location in the parasitic element.

24. The antenna of claim 21, wherein the first and second frequency range are included in a third frequency range over which the first radiating element is configured to operate.

25. The antenna of claim 21, further comprising a second radiating element disposed above the ground plane between one of the one or more parasitic elements and the first radiating element, the first radiating element being configured to operate within the first frequency range and the second radiating element being configured to operate within the second frequency range.

26. The antenna of claim 21, further comprising a low frequency band patch disposed above the ground plane and below the first radiating element in one direction and between two parasitic elements in another direction, the low frequency band patch being configured to operate within the first frequency range and the first radiating element being configured to operate within the second frequency range.

27. The antenna of claim 21, wherein the first frequency range and the second frequency cover a 55% bandwidth.

28. A method for providing a compact azimuth beamwidth in a wide band antenna comprising the steps of:
installing a first radiating element above a ground plane;
disposing one or more parasitic elements proximate to the first radiating element, each parasitic element being configured to control beamwidth across a first frequency range; and
forming a slot in each parasitic element, each slot being configured to control beamwidth across a second frequency range.

29. The method of claim 28, wherein the one or more parasitic elements are substantially rectangular.

30. The method of claim 29, wherein the slot in each of the one or more parasitic elements is substantially rectangular and disposed at a central location in the parasitic element.

31. The method of claim 28, wherein the first and second frequency range are included in a third frequency range over which the first radiating element is configured to operate.

32. The method of claim 28, further comprising the step of disposing a second radiating element above the ground plane between one of the one or more parasitic elements and the first radiating element, the first radiating element being configured to operate within the first frequency range and the second radiating element being configured to operate within the second frequency range.

33. The method of claim 28, further comprising the step of disposing a low frequency band patch above the ground plane and below the first radiating element in one direction and between two parasitic elements in another direction, the low frequency band patch being configured to operate within the first frequency range and the first radiating element being configured to operate within the second frequency range.

34. The method of claim 28, wherein the first frequency range and the second frequency cover a 55% bandwidth.
